(19) United States
(12) Patent Application Publication
(10) Pub. No.: US 2011/0208576 A1
(43) Pub. Date: Aug. 25, 2011

(54) FUEL LOYALTY REWARDS AND INCENTIVE PROGRAM

(75) Inventors: Jennifer Michelle DURGIN, Fairfax, VA (US); Jack Bittick MURRAY, Fairfax, VA (US); Jessica Joyce MCLAUGHLIN, San Francisco, CA (US); Matthew Donald AICHELE, Washington, DC (US); April Elise WEISBRUCH, Arlington, VA (US)

(73) Assignee: EXXONMOBIL RESEARCH AND ENGINEERING COMPANY, Annandale, NJ (US)

(21) Appl. No.: 13/032,276

(22) Filed: Feb. 22, 2011

Related U.S. Application Data
(60) Provisional application No. 61/308,283, filed on Feb. 25, 2010.
(60) Provisional application No. 61/358,230, filed on Jun. 24, 2010.

(51) Int. Cl. G06Q 30/00

(52) U.S. Cl. 705/14.38; 705/14.1

(57) ABSTRACT

A computer-implemented method of providing a discount for fuel to a customer is disclosed. The method includes identifying a customer to a retail store using a first reader device in operative communication with a host computer, which is communication with an identification module. The identification module creates and associates a customer with a customer identification record. A preliminary award record is created and maintained, which includes a discount-per-gallon award for fuel associated with the customer identification record in response to a purchase recognized by the host computer. The host computer adds subsequent preliminary award records to the preliminary award record associated with a customer identification to create an intermediate award record, which includes all the discount-per-gallon awards associated with the customer. A purchase of fuel is initiated by the purchaser at a fuel station with at least one fuel pump. The customer is identified by the fuel pump controller in operative communication with both a second reader device and a second identification module. The intermediate award record is retrieved by the host computer from a database and the host computer recognizes that the customer is eligible for a fuel station supplementary discount. A final discount record received by the customer and the customer is provided with the final discount associated with the final discount award record.

### CROSS REFERENCE TO RELATED APPLICATIONS

This application relates and claims priority to U.S. Provisional Patent Application No. 61/308,283, filed on Feb. 25, 2010 and U.S. Provisional Patent Application No. 61/358,230, filed on Jun. 24, 2010.

### TECHNICAL FIELD

The present application relates generally to a customer loyalty and fuel rewards program and, more particularly, to a customer loyalty and fuel rewards system which enables merchants, manufacturers, and fuel stations to provide a discount for fuel to a customer.

### BACKGROUND OF THE INVENTION

Vendors of all types may often find it desirable to enter into an agreement whereby a first vendor offers a discounted product or service to customers who shop at a second vendor. Such an agreement may result in an increase in revenue for both vendors. For example, the first vendor may receive more business than usual because of their discounted product, and the second vendor may also receive more business because they offer customers the opportunity to earn the discount at the first vendor.

Traditionally, the manner in which discounts are awarded are in the form of paper coupons or a printed voucher on a receipt. This is a disadvantage because the customer must keep track of the receipt to obtain the discount, and must keep track of multiple receipts if he earns multiple discounts. Further, the discounts traditionally offered are for finite currency discounts on a total purchase, e.g. $5 off if the customer spends $20. Again, this is a disadvantage because certain products, like fuel, are sold in units (gallons or liters) and the final cost of the purchase may be hard or impractical to estimate before a transaction occurs. Further, the discounts offered are traditionally based solely on the identify of the products purchased by the customer. This is a disadvantage because it doesn't allow vendors to offer their own rewards to incentivize consumer behavior other than which products the customer purchases.

An improved fuel loyalty reward system is described in U.S. Pat. No. 7,653,571 (the '571 patent) issued to Jacoves et al. on Jan. 26, 2010. In the '571 patent, Jacoves et al describes and illustrates a method for providing a discount-per-gallon for fuel to a customer who purchases certain goods. The customer receives a discount based on a threshold amount of goods and services, and those discounts are totaled for a final discount.

Although the method of the '571 patent may address some of the disadvantages described above, the design has certain limitations. In particular, the method only includes in the total discount the partial discounts based on a threshold amount of purchases, which limits the ability of vendors to customize the reward program and incentivize certain other consumer behavior that the vendor may desire.

The disclosed customer loyalty and fuel reward method and system in the present application is directed to overcoming one or more of the problems listed above

### SUMMARY OF THE INVENTION

In one aspect, the present invention disclosed herein is directed to a computer-implemented method of providing a discount for fuel to a customer, said method comprising: identifying a customer to a retail store by means of a first reader device in operative communication with a host computer, said host computer in communication with an identification module, said identification module creating and said customer thereby being associated with a customer identification record; creating and maintaining a preliminary award record at said host computer, said preliminary award record comprising a discount-per-gallon award for fuel associated with said customer identification record in response to a purchase recognized at said host computer; adding by means of said host computer said preliminary award record associated with said customer identification record to a subsequent said preliminary award record associated with said customer identification to determine an intermediate award record, wherein said intermediate award record comprises all the discount-per-gallon awards associated with the customer; storing said intermediate award record in a database, wherein a database module associates said intermediate award record with said customer identification record; initiating by the customer a purchase of fuel at a fuel station with at least one fuel pump, said initiating step including identifying a customer by a fuel pump controller in operative communication with both a second reader device and a second identification module; retrieving by said host computer said intermediate award record from said database; recognizing, through an interaction between said database and said host computer, that said customer is eligible for a fuel station supplementary discount, wherein said fuel station supplementary discount is associated with qualifying criteria other than said customer's purchase; creating from the interaction between said database and said host computer, a fuel station supplementary discount award record associated with said fuel station supplementary discount; adding, by a fuel pump controller operatively connected to said host computer, said intermediate award record to said fuel station supplementary discount award record to determine a final discount record; receiving by the customer, an amount of fuel having an associated total cost; providing said customer an option to redeem the final discount associated with the final discount award record; and reducing by said fuel pump the cost of said fuel by said final discount record, if said customer chooses said option.

In another aspect, the present invention disclosed is directed to a computer-implemented method of providing a discount for fuel to a customer, said method comprising: identifying a customer to a retail store by means of a first reader device in operative communication with a host computer, said host computer in communication with an identification module, said identification module creating and said customer thereby being associated with a customer identification record; creating and maintaining a preliminary award record at said host computer, said preliminary award record comprising a discount-per-gallon award for fuel associated with said customer identification record in response to a purchase recognized at said host computer; recognizing, through said host computer, that the customer is eligible for a retail store supplementary discount, wherein said retail store supplementary discount is associated with qualifying criteria other than the customer's purchase; creating at said host computer, a retail store supplementary discount award record associated with said retail station supplementary discount; adding by means of said host computer said preliminary award record associated with said customer identification record to a subsequent said preliminary award record associated with said customer identification, and said retail store supplementary discount award record associated with a particular customer identification record to determine a final discount award record, wherein said final discount award record comprises all the discount-per-gallon awards associated with the customer and said retail store supplementary discount; storing the final discount award record in a database, wherein a database module associates the final discount award record with the customer identification record; initiating by the customer a purchase of fuel at a fuel station with at least one fuel pump, said initiating step including identifying a customer by a fuel pump controller in operative communication with both a second reader device and a second identification module; retrieving by said host computer the final discount award record from the database; receiving by the customer, an amount of fuel having an associated total cost; providing said customer an option to redeem a final discount associated with the final discount award record; and reducing by the fuel pump the cost of the fuel by the final discount, if said customer chooses said option.

In another aspect, the present invention disclosed is directed to a computer-implemented method of providing a discount for fuel to a customer, said method comprising: identifying a customer to a retail store by means of a first reader device in operative communication with a host computer, said host computer in communication with an identification module, said identification module creating and said customer thereby being associated with a customer identification record; creating and maintaining a preliminary award record at said host computer, said preliminary award record comprising a discount-per-gallon award for fuel associated with said customer identification record in response to a purchase recognized at said host computer; recognizing, through said host computer, that the customer is eligible for a retail store supplementary discount, wherein said retail store supplementary discount is associated with qualifying criteria other than the customer's purchase; creating at said host computer, a retail store supplementary discount award record associated with said retail station supplementary discount; adding by means of said host computer said preliminary award record associated with said customer identification record to a subsequent said preliminary award record associated with said customer identification, and said retail store supplementary discount award record associated with a particular customer identification record to determine an intermediate discount award record, wherein said intermediate discount award record comprises all the discount-per-gallon awards associated with the customer and said retail store supplementary discount; storing the intermediate discount award record in a database, wherein a database module associates the intermediate discount award record with the customer identification record; initiating by the customer a purchase of fuel at a fuel station with at least one fuel pump, said initiating step including identifying a customer by a fuel pump controller in operative communication with both a second reader device and a second identification module; retrieving by said host computer said intermediate award record from said database; recognizing, through an interaction between said database and said host computer, that said customer is eligible for a fuel station supplementary discount, wherein said fuel station supplementary discount is associated with qualifying criteria other than said customer's purchase; creating from the interaction between said database and said host computer, a fuel station supplementary discount award record associated with said fuel station supplementary discount; adding, by a fuel pump controller operatively connected to said host computer, said intermediate award record to said fuel station supplementary discount award record to determine a final discount record; receiving by the customer, an amount of fuel having an associated total cost; providing said customer an option to redeem the final discount associated with the final discount award record; and reducing by said fuel pump the cost of said fuel by said final discount record, if said customer chooses said option.

In another aspect, the present invention disclosed is directed to a computer-implemented method of providing a discount for fuel to a customer, said method comprising: identifying a customer to a retail store by means of a first reader device in operative communication with a host computer, said host computer in communication with an identification module, said identification module creating and said customer thereby being associated with a customer identification record; recognizing, through said host computer, that the customer is eligible for a retail store supplementary discount; creating at said host computer, a retail store supplementary discount award record associated with said retail station supplementary discount; storing said retail store supplementary discount award record in a database, wherein a database module associates said retail store supplementary discount award record with the customer identification record; initiating by the customer a purchase of fuel at a fuel station with at least one fuel pump, said initiating step including identifying a customer by a fuel pump controller in operative communication with both a second reader device and a second identification module; retrieving by said host computer said retail store supplementary discount award record from said database; receiving by the customer, an amount of fuel having an associated total cost; providing said customer an option to redeem the retail store supplementary discount award associated with the retail store supplementary discount award record; and reducing by said fuel pump the cost of said fuel by said retail store supplementary discount award record, if said customer chooses said option.

In another aspect, the present invention disclosed is directed to a system for providing a discount for fuel to a customer, said system comprising: a retail store point-of-sale for: enabling a customer to make at least one qualifying purchase; awarding the customer at least one discount-per-gallon in response to the at least one purchase; adding a plurality of at least one discounts-per-gallon to determine a first intermediate discount-per-gallon; and awarding the customer a retail store supplementary discount; a first reader connected to the retail store point-of-sale for reading a first customer identification; a database for storing first intermediate discount-per-gallon and the retail store supplementary discount and associating both discounts with the customer; a nozzle for dispensing the fuel; a second reader connected to the fuel station point-of-sale for reading a second customer identification; a fuel station point-of-sale for: enabling a customer to make at least one fuel purchase associated with a total cost; awarding the customer a fuel station supplementary discount; adding the first intermediate discount-per-gallon, retail store supplementary discount, and fuel station supplementary discount to determine a final discount; and subtracting the final discount from the total cost.

In another aspect, the present invention disclosed is directed to a system for providing a discount for fuel to a customer, said system comprising: means for identifying a customer by a store; means for awarding at least one discount-per-gallon for fuel to the customer in response to at least one purchase; means for adding said discounts-per-gallon to determine a first intermediate discount-per-gallon for fuel; means for awarding at least one supplementary discount; means for storing the first intermediate discount and the supplementary discount; means for identifying a customer by a fuel station; means for distributing fuel to the customer; means for adding the first intermediate discount and the supplementary discount to determine a final discount; and means for reducing the cost of the fuel by the final discount.

### BRIEF DESCRIPTION OF THE DRAWINGS

FIG. 1 is a diagram of one embodiment of the retail store system.

FIG. 2 is a diagram of one embodiment of the fuel station system.

FIG. 3 is a diagram of one possible example of a customer transaction record and rewards accrual.

FIG. 4 is a diagram showing a possible information sharing arrangement between the fuel pump, database, and retail store possible interface between a participating customer and fuel pump display.

FIG. 5 is a diagram of one possible example of interactions between the customer, retail store POS, and fuel station POS.

FIG. 6 is a diagram of a possible embodiment of a customer transaction record and rewards accrual in a ‘tiered’ system.

FIG. 7 is a diagram of two possible ways that a customer might be ‘promoted’ between tiers of a loyalty system.

### DETAILED DESCRIPTION

The present application is directed toward a method for providing a discount on fuel to a customer in response to the customer's behavior.

One possible embodiment of the invention may be conducted as follows: a customer could first visit a participating retail store and make a purchase qualifying him to receive a reward. The customer may identify himself at the retail point of sale (“POS”). The POS system may determine the reward earned by the customer's purchase of the qualifying good, and the reward is associated with the specific customer. The reward associated with the customer could qualify him to receive a discount per gallon (“DPG”) of fuel (or some other reward). If the customer makes multiple qualifying purchases that result in DPG rewards, they may be added together at the retail POS (e.g., if the purchase of a two-liter bottle of a certain brand name soda earns the customer a discount of $0.02 per gallon, and the purchase of one pound of apples earns the customer a discount of $0.03 per gallon, by purchasing both items the customer earns a discount of $0.05 per gallon). The discount representing the sums of all the smaller discounts earned from the purchase of qualifying goods at the retail store is the first intermediate DPG (FI-DPG). In the example described above, the customer's FI-DPG would be $0.05 per gallon. The retail store could then add its own Retail Store Supplementary Discount (RSSD) to the FI-DPG. The RSSD is not based on the purchase of qualifying products, but instead could be based on any number of market-based factors, for example the customer's frequency of visits to the store. It could also offer a way for vendors participating in the fuel rewards program to incentivize participants to earn rewards through their location. The POS at the participating grocery store might recognize that, for example, the customer has shopped at the grocery store for the qualifying third time in a week, and on that third visit the customer is awarded the RSSD on top of his previously earned FI-DPG. The RSSD may be offered in the form of DPG, cash discount ('$1.00 off your next fuel purchase'), or a combination thereof. If the grocery store offers an RSSD of $0.03 per gallon on the third visit within a week, and the aforementioned customer earns this discount, he has now earned a second intermediate discount (SID) of $0.08 per gallon.

The store computer at the POS checkpoint may also have an identification module which can create an identification record for each customer. In an alternative embodiment, the store computer does not have to recognize or identify the customer, but may instead recognize a card via a card identifier (e.g., the BIN number on a stored value card). For the purposes of this invention, “customer identification”. may include identification of a customer, identification of an account associated with a customer, or identification of an account authorized by a retailer.

Once the store computer has recognized or identified either the customer or the card, the store computer may create a customer identification record. The store computer may also be able to recognize qualifying purchases and create a preliminary award record, which the computer may associate with the customer identification record. The computer might then add any preliminary award records to create an intermediate award record. If the customer or card user is eligible for a retail store supplementary discount, the store computer might also create and add a retail store supplementary discount award record to the intermediate discount award record.

The preliminary award record, award record, or intermediate award record created from the retail store transaction may then be stored in a database, in which a database module associates the customer's preliminary award record, award record, or intermediate award record with a customer identification record. When the customer initiates a fuel purchase, a fuel pump controller may be connected to the fuel pump reader and a second identification module. The fuel pump controller may retrieve the intermediate award record from the database.

The customer may subsequently visit a fuel station. He may pump his fuel at the posted rate per gallon. If paying for the transaction at the pump using, for example, a credit card, debit card, gift card, or voucher, the customer may identify himself at the fuel pump. In an alternate embodiment, a customer using cash to purchase fuel may identify himself after the fuel has been pumped when the customer enters the fuel station to purchase the fuel.

If the customer identifies himself at the fuel pump (or, if the customer's card or account number is recognized at the fuel pump), the display at the fuel pump may then offer the customer, after dispensing the fuel at the posted price, the option of redeeming his discount. If the customer chooses not to redeem, all discounts may accrue in the database until the customer opts to use them (subject to a maximum discount or fuel amount). If the customer does choose to redeem the discount, or if the system automatically applies the discount, the fuel station could then award its own Fuel Station Supplementary Discount (FSSD) based on any manner of consumer behavior they hope to incentivize. Like the RSSD, the FSSD may also be offered in the form of DPG, cash discount (‘$1.00 off your next fuel purchase’), or a combination thereof. The FI-DPG or SID may then be added to the FSSD to calculate a final discount. The total cost of the fuel may then be reduced by the final discount. So, the customer could pump his gas at the posted rate and then identify himself to obtain his previously earned $0.08 per gallon SID. He may then be notified that he is also receiving an FSSD of $0.02 per gallon because he has visited this gas station three times in one week, making his final discount $0.10 per gallon. The customer then would pump 10 gallons of gas at the posted price-per-gallon of $2.00, for a total cost of $20.00. The fuel pump interface could then show a decrease in the total cost of the fuel from $20.00 to $19.00. The customer pays the $19.00 and completes one embodiment of the rewards cycle.

The FSSD, if the customer is eligible for one, might be created as a result of the interaction between the database and fuel pump. The interaction might also result in the creation of a FSSD award record. The intermediate award record, or award record, may then be added to the FSSD award record, to determine a final discount record. The customer may then pump some amount of fuel resulting in a total cost, and might be offered the option of whether he wishes to redeem his rewards. If he chooses yes, the final discount amount associated with the final discount record is subtracted from the total cost.

An embodiment of the system contemplates a number of ways to define a qualifying purchase for each transaction, including purchase of a specific, cross-marketed product (e.g., brand name products), purchase of a threshold currency amount (e.g., over $50), purchase of a certain quantity of items (e.g., three brand name products), purchase of a threshold currency amount from a specific department (e.g., over $20 spent in bakery section), or any other way to define qualifying purchase(s).

An embodiment of the system allows the customer or an account associated with the customer to be identified at both the retail POS and the fuel pump. The POS may be connected to the fuel pump or fuel station through a database. The proposed system contemplates using at least one of any number of identification means, including a credit, debit, or any other type of card with a magnetic strip, a frequent shopper card, a stored value card, a gift card, a Smart Card, a loyalty program card with a bar code, a store credit card, a printed store receipt with a bar code, a personal identification number entered manually, an Exxon Mobil Speedpass™ radio frequency identification (RFID) device, biometric data, or any other identification system that can associate the customer with his particular purchases and earned rewards. Such an identification system would also include allowing multiple members on a single account or loyalty card to jointly earn and use discounts (or to set up a primary discriminator on the account who would select users to redeem any earned rewards). Participants in the system may utilize the same identification means, or they may each use a different selected identification means within a set of identification means accepted by retail stores, service providers, or fuel stations. Further, multiple individuals may be associated with one customer identification. For example, a father, mother, and child may all receive fuel loyalty cards which, when used at a retail store to make a qualifying purchase, deposit the earned rewards into a shared account. In this embodiment, the multiple individuals may be entitled to earn rewards for a single account. Once the rewards have been accrued and are ready to be awarded at the pump, the present invention may allow all of the individuals to redeem the award, or it may allow a smaller subset of the individuals to redeem the award. For example, if a father, mother, and child all use loyalty cards to accrue rewards, the system may allow them to designate that only the child has the ability to redeem the reward at the pump.

Reading devices might be required in order to identify a customer at the store. Such reading devices would be in communication with a host computer, which could be locally located at the site of the store, remotely located at another site, or may comprise a cloud computing environment. Any utilized reading devices would need to be compatible with some combination of the possible identification means described herein.

An embodiment of the system also may include a retail store supplementary discount (RSSD), possibly in the form of DPG, cash discount ($1.00 off your next fuel purchase'), or a combination thereof. The RSSD is based on some factor other than the customer's purchase in the store. The customer cannot redeem the FI-DPG until the customer is eligible for a supplementary discount (either an RSSD, a FSSD, or both), so the RSSD might be needed to ‘trigger’ the customer's initial purchase earned as a result of a qualifying purchase. The RSSD allows retailers to incentivize not only specific purchases, but to incentivize other desirable customer behavior as well. For example, a retail store may provide a RSSD for customers who shop during non-peak hours (or non-peak days), thus lessening the crowds during peak hours (or days). This type of reward could be marketed as a “retail rewards hour.” A store could also provide a RSSD based on the form of a lottery or game, for example awarding every 200^{th} customer $3.00 per gallon. This award may be allowed to exceed the maximum second intermediate discount (SID) allowed under normal circumstances. In another embodiment, a store could provide a RSSD to customers using a certain type of identification device, for example awarding an extra $0.05 per gallon for customers using an Exxon Mobil Speedpass™, to incentivize such behavior. Other possible RSSDs that could be applied to a current transaction include rewarding for the number of alliance members visited; grade of gas purchased in current and/or prior transactions; recruiting additional members to the program; consumer status (which is a quality associated with a customer before the current sales transaction, and may refer to individual status, for example as a member of AARP, or may refer to status in a tiered level of the program, membership in a particular group, membership in a community group with shared accounts or any other type of “status”); achievement of a qualifying criteria (which is a condition met by a customer by reason of a current sale, whereupon the award is calculated, e.g., frequency of purchases at or visits to the fuel station, tiered discounts based on fuel grade, time of purchase, or any other type of qualifying criteria which a store might want to incentivize).

An embodiment of the system also includes a fuel station supplementary discount (FSSD), possibly in the form of DPG, cash discount ($1.00 off your next fuel purchase'), or a combination thereof. Like the RSSD, the FSSD is based on some factor other than customer's purchase in the store. The FSSD may include any of the RSSD rewards mentioned above. The customer cannot redeem the FI-DPG until the customer is eligible for a supplementary discount (either an RSSD, FSSD, or both), so the FSSD might be needed to ‘trigger’ the customer's initial purchase earned as a result of a qualifying purchase. The FSSD allows fuel stations to incentivize desirable customer behavior by offering a fuel discount to customers who engage in the desirable behavior. For example, a fuel station may provide a FSSD to customers who have previous visited the particular fuel station within the past week, further incentivizing customer loyalty. A fuel station could also provide a FSSD to customers who visit the fuel station at non-peak hours (or non-peak days), thus lessening the crowds during peak hours (or days). This type of FSSD could be marketed as a “fuel rewards hour.” Many of the possible ways to offer an RSSD might also apply to offering the FSSD. In addition, a fuel station might provide an FSSD based on the “age” of the FI-DPG, the temporal proximity to the purchase in the retail store (e.g., if the customer visits the fuel station within 3 days of earning an FI-DPG, the customer gets an automatic $2.00 off purchase FSSD). Although the FSSD may be added to the FI-DPG or SID to give the customer a final discount, the final discount awarded to the customer may also include any other intervening discount awarded by the retail store, fuel station, or any other party.

Of course, there are many possible variations on the system described herein. The program may include a system with an RSSD, or a system with an FSSD, or a system where both supplementary rewards are offered to the customer. In any case, however, the customer must be eligible for a supplementary discount before he or she can redeem the FI-DPG. The FI-DPG, RSSD, SID, FSSD, and final discount (or any combination thereof) could also possibly be subject to a maximum amount (e.g., in gallons) to which the discount can be applied. In addition, the system might allow the customer to choose not to redeem any discounts, in which case all discounts may accrue in the database until the customer opts to use them (which may be subject to a maximum discount, either based on the amount of the discount, or the amount of fuel to which the discount might be applied).

In a specific variation on this exemplary embodiment, the method claimed above may be altered by removing the purchasing criteria altogether, and just awarding an RSSD and a FSSD. For example, a customer may obtain a reward of $0.10 off per gallon of fuel just for shopping at a designated grocery store (not in response to any purchasing behavior) and may then obtain a reward of $0.10 off per gallon from a fuel station based on any number of the non-purchase based behavior, as described above. The two accrued discounts may then be cross-stacked and applied to a purchase of fuel. The awarded discounts may be applicable to a maximum number of gallons per visit. This embodiment may be implemented in conjunction with any other embodiments or methods described herein.

In another embodiment, rather than adding cents-per-gallon, the reward system adds a customer's earned rewards in gallons. A customer is awarded a standard, static discount-per-gallon for achieving a purchasing behavior at a retail store. The discount-per-gallon (e.g. $0.50 per gallon) would be a fixed amount that would not change as purchases increased. Instead, the purchases at the retail store would increase the number of gallons to which a customer would be allowed to apply the discount. For example, if the standard discount was $0.50 per gallon, a customer buying a specific product from a retail store might earn one gallon of credit, and could then purchase one gallon of fuel at $0.50 off per gallon. Similarly, if the customer purchases some threshold dollar amount from a retail store, the customer may earn ten gallons of credit, and could then purchase ten gallons of fuel at $0.50 off per gallon. Alternatively, the customer might choose to ‘stack’ the gallons and redeem $0.50 off for 11 gallons in the next fuel transaction.

The static discount-per-gallon may be a significant amount (such as 90-95% of the current price of fuel) such that the customer is earning almost free gas. The gallon credits awarded to the customer might also be awarded in fractional quantities, e.g. earning 0.01 gallons of discounted fuel for every $1 spent at a retail store.

This embodiment may be carried out, as an example, in the following way: A customer signs up to become a member in the fuel rewards loyalty program, and is awarded the entry-level standard discount of 10 cent discount per gallon. The customer visits a participating retailer and makes a qualifying purchase by spending a threshold amount of $100. The customer earns four gallons for the purchase at the retail store, making the customer's total earned gallonage (TEG) 4 gallons. The customer has the option to then redeem the 10 cents/4 gallon discount at a fueling station, but does not.

The customer then visits another participating retail store, and makes two distinct qualifying purchases in the same transaction: three two-liter bottles of soda, and four packages of cookies. The purchase of the soda earns the customer 1 gallon of discounted gas (GDG), and the purchase of the cookies earns the customer 2 GDG. The customer's TEG for the present transaction is 3 gallons, and the customer's overall total earned gallonage (O-TEG) is 7 gallons. The customer has the option to then redeem the 10 cents/7 gallon discount at a fueling station, but does not.

The customer visits a third retail store, and purchases a cross-marketed product that earns the customer 3 more gallons, making the customer's O-TEG 10 gallons. The customer subsequently initiates a fuel transaction at a fuel pump, identifying himself in a way so that his reward information may be located in a database (this might mean using a rewards card, credit card, RFID tag, entering a pin number, etc.). The customer pumps 15 gallons of fuel at the posted price of $2.00/gallon. The customer is informed that he has a rewards account with a 10 cent per gallon discount for 10 gallons of gas, and is asked if he would like to redeem the awards (or any portion of the award) in the present transaction. The customer then chooses to redeem all earned rewards, and the total cost of the gas is discounted from $30.00 to $29.00.

The customer uses the rewards account frequently for several months, continuously earning a 10 cent discount per gallon on some number of gallons for making qualifying purchases at participating retailers. After six months, the customer is informed that he is qualified to receive a Standard-Level Discount (SLD) of 25 cents per gallon. There may be several other levels existing within the system, each with its own standard level discount (SLD) of some static amount. The ‘higher’ level SLDs might offer either a higher discount in cents-per-gallon or a higher maximum gallonage to which the discount might apply, both, or some other incentive. The customer continues to earn gallons by making qualifying purchases (as described above, or otherwise) at participating retail stores, now earning 25 cent discounts off earned gallonage.

A system adding gallonage may be implemented in conjunction with any other embodiments or methods, described herein or otherwise. Such a system may be used in conjunction with the earlier described method using RSSDs and/or FSSDs. Alternatively, it may be implemented without the formation of an alliance, or in combination with some other method to provide fuel rewards to a customer.

In another embodiment, the proposed fuel loyalty reward program will award standard, static discounts-per-gallon based on the status of a customer. For example, a fuel company may created a Loyalty Membership program with three ‘tiered’ levels, 1, 2, and 3. All new participants may begin at the level 1, which would entitle them to a standard discount of $0.05 per gallon on all fuel purchases. Upon achievement of a certain criteria (purchasing a threshold amount of gas per month, purchasing an upgrade, using a co-branded card, etc.,) the level 1 customer may be promoted to level 2. Level 2 customers would be entitled to a higher standard discount of $0.10 per gallon on all fuel purchases. Upon achievement of another criteria, the level 2 customer may be promoted to a level 3 customer. Level 3 customers would be entitled to a higher standard discount of $0.25 per gallon on all fuel purchases. A program might also allow for incentives to be given that would encourage customers to achieve the criteria to increase their ‘level,’ or ‘tier,’ for example, by allowing customers to redeem previously earned gallonage rewards at the new, higher-tier discount per gallon. The tiered structure above may also be based on other criteria, such as the grade of gas purchased. “Premium” members purchasing premium grade gas would receive “premium” level discounts.

In another embodiment of the present invention, the RSSDs and FSSDs improve upon systems known in the prior art. Participating retailers in the present invention can allow customers to earn additional discounts per gallon through certain criteria set by the store which are unrelated to the customers' purchases within the store (e.g., frequency of visits). For example, a retailer could award a discount for use of a stored value card associated with a retailer. This incentivizes customer behavior. The present system also allows for the cross-promotional and cross-marketing opportunities.

Any of the inventive concepts described herein may be used in conjunction with any other inventive concept described herein. For example, the ‘tiering’ of fuel rewards may be implemented in conjunction with any other embodiments or methods, described herein or otherwise. In one such combination, a customer's “level” might be the RSSD or FSSD itself ‘Tiering’ may also be utilized in combination with the embodiment described above wherein gallonage is added to calculate fuel rewards; for example, differently tiered customers would earn different gallonage for the same purchases (as opposed to earning a higher discount in response to the same purchase).

As used in the following figures and descriptions, operative communication or operative connection may include any type of wired or wireless communication, including but not limited to the internet, local area networks, wide area networks, wireless networks, telephone lines, satellite communication, or any such type of electronic communication capable of transmitting and receiving data.

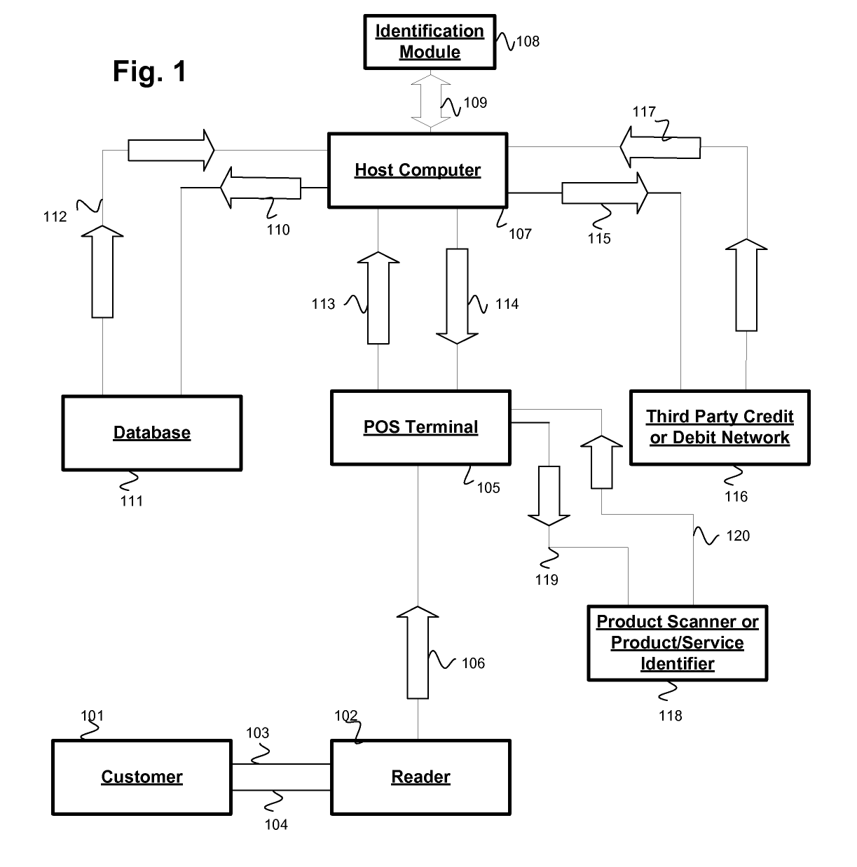

Referring to FIG. 1, a customer 101 identifies himself by inputting at a reader 102 an identification means 103 and, in one embodiment, a payment means 104. The identification means 103 may include a credit, debit, or any other type of card with a magnetic strip, a frequent shopper card, a loyalty program card with a bar code, a store credit card, a printed store receipt with a bar code, a personal identification number entered manually, an Exxon Mobil Speedpass™ radio frequency identification (RFID) device, biometric data, or any other identification device that can associate the customer with his particular purchases and earned rewards. The payment means 104 may include a credit, debit, or any other type of card with a magnetic strip, a frequent shopper card, a loyalty program card with a bar code, a store credit card, a printed store receipt with a bar code, a personal identification number entered manually, an Exxon Mobil Speedpass™ radio frequency identification (RFID) device, biometric data, or any other payment device that can associate the customer with a particular source of funds available for use to purchase fuel. Identification means 103 and payment means 104 may comprise a single device (e.g. a credit card could serve as both identification means 103 and payment means 104). Alternatively, identification means 103 and payment means 104 may comprise separate devices (e.g., a credit card could serve as payment means 104 while a loyalty program card with a barcode could serve as identification means 103).

The reader 102 may be operatively connected 106 to a point of sale terminal 105 which in the preferred embodiment may be located local to the retail store. After the reader 102 receives the identification data from identification means 103 and provides the data to the point of sale terminal 105, the point of sale terminal 105 transmits the identification data to a host computer 107 via an operative connection 113. The host computer 107 may be in operative communication 109 with an identification module 108 to create a customer identification record. The host computer 107 and the identification module 108 may be located in the same server or database, or one may be located remotely from the other. Further, the host computer 107 and point of sale terminal 105 may be located in the same computer, server or database, or they may be located remotely from one another.

The customer identification record may by operatively communicated 110 to a database 111. Database 111 may store customer identification records associated with customers. Upon receipt of the customer identification record from the host computer 107, the database 111 may compare the customer identification record to the existing customer identification records to determine if such a customer identification record already exists. If no such record exists, the database 111 stores the customer identification record and associates all discounts earned during the instant transaction with the new customer identification record. If an existing customer identification record exists, the database 111 associates all discounts earned during the instant transaction with the existing customer identification record.

Prior to or after customer identification, customer 101 may present goods or services to be purchased to product scanner or product/service identifier 118. Product scanner or product/service identifier 118 may identify such products or services by, for example, a universal product code (UPC). Product scanner 118 may then transmit product information back to the point of sale terminal 105 by an operative connection 120. Point of sale terminal 120 may then transmit at 113 to host computer 107 the product information. The product information may include a quantity, price, weight, UPC, or any other identification associated with the purchased product or service. This information is used to create and maintain a preliminary award record at host computer 107. A preliminary award record may be a discount-per-gallon associated with a product or service purchased by customer 101 and identified by product scanner 118.

The host computer 107 may then add the preliminary award record to a subsequent preliminary award record to determine an intermediate award record associated with customer 101. The intermediate award record may then be transmitted at 110 by the host computer 107 to the database 111. Database 111 may then store the intermediate award record and associate it with a customer identification record.

The customer identification record may by operatively communicated 110 to a database 111. Database 111 may store customer identification records associated with customers and may also store intermediate award records associated with certain customer identification records. Upon receipt of the customer identification record from the host computer, the database 111 may compare the customer identification record to the existing customer identification record to determine and then provide to the host computer 107 any intermediate award record 112 associated with said customer 101.

Before or after the host computer 107 transmits the intermediate award record to the database 111, the host computer 107 may further determine if the customer 101 is eligible for a retail store supplementary discount associated with a qualifying criteria other than a purchase by the customer 101. If the host computer 107 determines that customer 101 is eligible for a retail store supplementary discount, a retail store supplementary discount award record associated with said retail store supplementary discount is created and transmitted to database 111, where it is associated with the customer identification record.

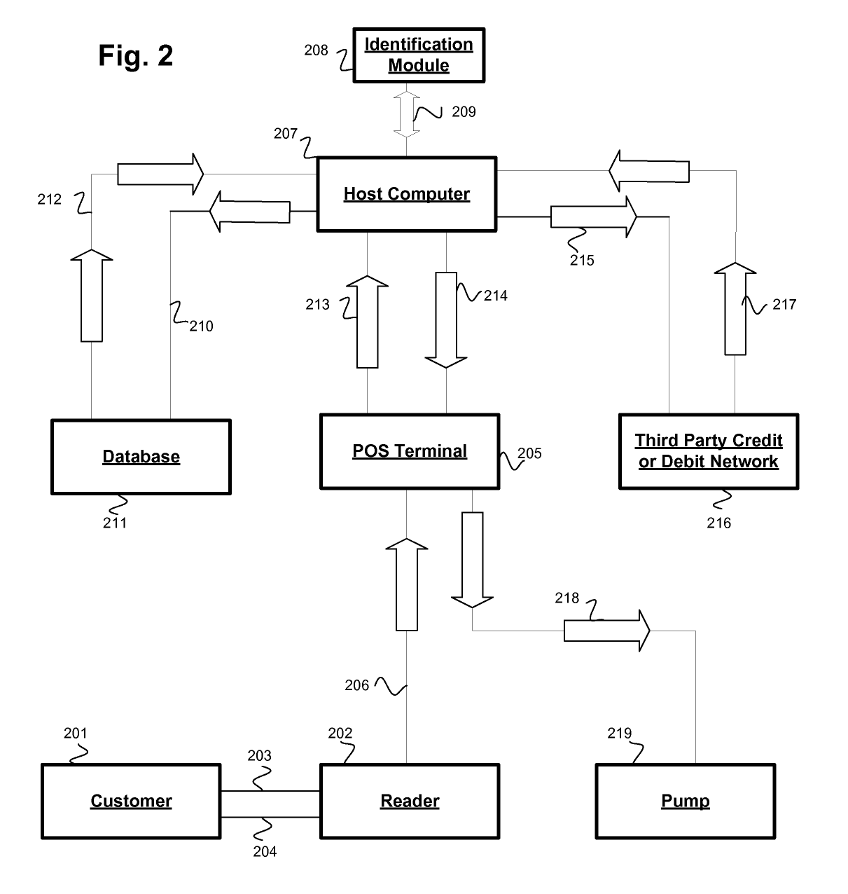

In one embodiment, the intermediate award record and/or the retail store supplementary award record are stored in the database 111 until a customer initiates a fuel purchase as will be described in FIG. 2. In another embodiment, the intermediate award record and retail store supplementary award record are added by host computer 107 to determine a final discount to be awarded toward the purchase of fuel at a fuel station. Alternatively, the point of sale terminal 105 may perform the calculation to determine the final discount record.

As described above, the reader 102 may also receive payment information from customer 101 via a payment means 104. The reader 102 may then transmit the payment information to the point of sale terminal 105 by an operative connection 106. The point of sale terminal 105 may then transmit the payment data to the host computer 107 by an operative connection 113.

The host computer 107 may transmit the payment information at 115 to a third party credit or debit network 116, such as an electronic payment network or a credit card provider. The third party credit or debit network 116 may compare the payment information to an internal database to determine if the customer 101 is authorized (i.e., has enough funds or credit) to purchase the products or services identified by product scanner or product/service identifier 118. If the third party credit or debit network 116 determines the transaction should be authorized, it may transmit at 117 an authorization to the host computer 107 to allow customer 101 to proceed with the transaction. The host computer 107 may then transmit the authorization via the operative connection 114 to the point of sale terminal 105, thus enabling the customer to proceed with the transaction and receive discounts associated with his purchases and any such retail store supplementary discount if the retail store so provides.

Referring to FIG. 2, a customer 201 identifies himself by inputting at a reader 202 an identification means 203 and, in one embodiment, a payment means 204. The identification means 203 may include a credit, debit, or any other type of card with a magnetic strip, a frequent shopper card, a loyalty program card with a bar code, a store credit card, a printed store receipt with a bar code, a personal identification number entered manually, an Exxon Mobil Speedpass™ radio frequency identification (RFID) device, biometric data, or any other identification device that can associate the customer with his particular purchases and earned rewards. The payment means 204 may include a credit, debit, or any other type of card with a magnetic strip, a frequent shopper card, a loyalty program card with a bar code, a store credit card, a printed store receipt with a bar code, a personal identification number entered manually, an Exxon Mobil Speedpass™ radio frequency identification (RFID) device, biometric data, or any other payment device that can associate the customer with a particular source of funds available for use to purchase fuel. Identification means 203 and payment means 204 may comprise a single device (e.g. a credit card could serve as both identification means 203 and payment means 204). Alternatively, identification means 203 and payment means 204 may comprise separate devices (e.g., a credit card could serve as payment means 204 while a loyalty program card with a barcode could serve as identification means 203).

The reader 202 may be operatively connected 206 to a point of sale terminal 205 which in the preferred embodiment may be located local to the fuel station. After the reader 202 receives the identification data from identification means 203 and provides the data to the point of sale terminal 205, the point of sale terminal 205 transmits the identification data to a host computer 207 via an operative connection 213. The host computer 207 may be in operative communication 209 with an identification module 208 to create a customer identification record. The host computer 207 and the identification module 208 may be located in the same server or database, or one may be located remotely from the other. Further, the host computer 207 and point of sale terminal 205 may be located in the same computer, server or database, or they may be located remotely from one another.

The customer identification record may by operatively communicated 210 to a database 211. Database 211 may store customer identification records associated with customers and may also store intermediate award records associated with certain customer identification records. Upon receipt of the customer identification record from the host computer, the database 211 may compare the customer identification record to the existing customer identification record to determine and then provide to the host computer 207 any intermediate award record 212 associated with said customer 201. Data base 211 may also provide to the host computer 207 any retail store supplementary award record associated with the customer identification record.

Once the host computer 207 retrieves the intermediate award record and any eligible retail store supplementary award records from the database 211, the host computer 207 may further determine if the customer 201 is eligible for a fuel station supplementary discount associated with a qualifying criteria other than a purchase by the customer 201. If the host computer 207 determines that customer 201 is eligible for a fuel station supplementary discount, a fuel station supplementary discount award record associated with said fuel station supplementary discount is created.

If the host computer 207 determines that the customer 201 is eligible for a fuel station supplementary discount, or if the customer 201 has already received another type of supplementary discount, the host computer 207 may add the intermediate award record received from database 211 to the fuel station supplementary discount award record, or accept an intermediate award that has previously earned a supplementary discount as a final award, to determine a final discount record and transmit said final discount record to point of sale terminal 205 via an operative connection 214. Alternatively, the point of sale terminal 205 may perform the calculation to determine the final discount record.

As described above, the reader 202 may also receive payment information from customer 201 via a payment means 204. The reader may then transmit the payment information to the point of sale terminal 205 via an operative connection 206. The point of sale terminal 205 may then transmit the payment data to the host computer 207 via an operative connection 213.

The host computer 207 may transmit the payment information at 215 to a third party credit or debit network 216, such as an electronic payment network or a credit card provider. The third party credit or debit network 216 may compare the payment information to an internal database to determine if the customer 201 is authorized (i.e., has enough funds or credit) to purchase fuel at point of sale terminal 205. If the third party credit or debit network 216 determines the transaction should be authorized, it may transmit at 217 an authorization to the host computer 207 to proceed with the transaction. The host computer 207 may then transmit the authorization via the operative connection 214 to the point of sale terminal 205.

After receiving the authorization, point of sale terminal 205 may transmit a signal at 218 to a pump 219 to allow customer 201 to begin the purchase of fuel. The point of sale terminal 205, after dispensing the fuel and determining a total cost associated with the fuel, may then decrease the determined total cost of the fuel by the final discount associated with the final discount record. Alternatively, the host computer 207 may decrease the determined total cost of the fuel by the final discount associated with the final discount record.

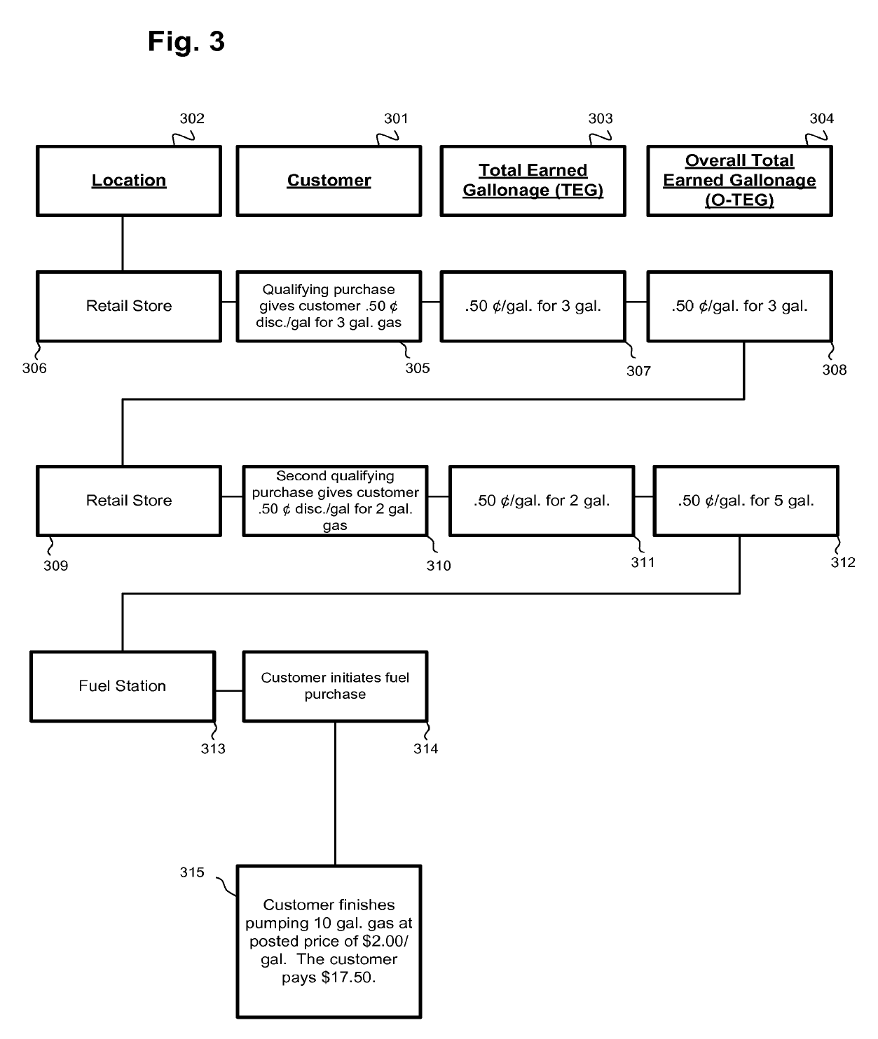

Referring to FIG. 3, in one embodiment of the present invention the customer 301 is awarded and redeems gallonage discounts at various retail locations 302 which may or may not be members of an alliance. The customer's 301 total earned gallonage (“TEG”) 303 is accumulated, totaled, and stacked as Overall Total Earned Gallonage (“O-TEG”) 304 to eventually give the customer a final award. In this embodiment, the customer makes some qualifying purchase 305 at a first retail store 306. The reward for the qualifying purchase is $0.50/3 gallons 307. The customer's O-TEG is $0.50/3 gallons 308.

The customer visits the second retail store 309 and makes another qualifying purchase 310. This purchase earns the customer $0.50/2 gallons 311. The customer's O-TEG is now $0.50/5 gallons 312.

The customer subsequently visits a fuel station 313 and initiates a purchase of fuel 314. The customer pumps 10 gallons of gas at the posted price of $2.00/gallon. The O-TEG 312 is awarded to the customer after pumping, and the customer pays $17.50 for the gas 315.

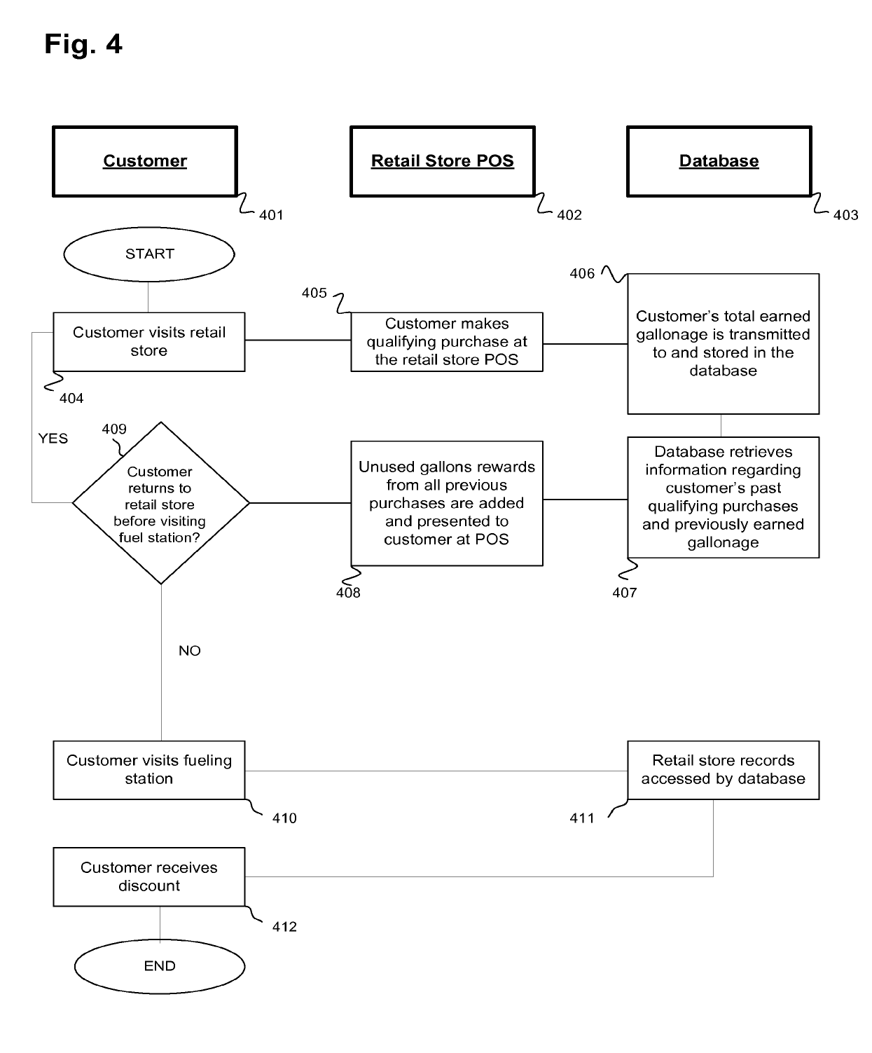

Referring to FIG. 4, one possible interaction between a customer 401, retail store point of sale 402, and database 403, begins with the customer's visit to the retail store at 404. The customer makes qualifying purchases at the store POS at 405, entitling the customer to earned discounted gallonages, which are then totaled by the database at 406. The database 403 retrieves information about the customer's stored rewards at 407. The customer is awarded the total of all unused and earned rewards at 408 at the POS 402. The customer then has the option of subsequently returning to the retail store before visiting a fueling station. If the customer does return to the retail store at 409 and make more qualifying purchases, steps 404-408 are repeated, and the customer will have more rewards for use at the fuel station.

If the customer does not return to the retail store at 409 before visiting the fueling station at 410, the customer initiates a transaction at the fuel pump. The database 403 accesses records pertaining to customer's overall total earned gallonage (“O-TEG”) at 411. The customer, and may or may not have the option to use the discount, then receives the discount at 412.

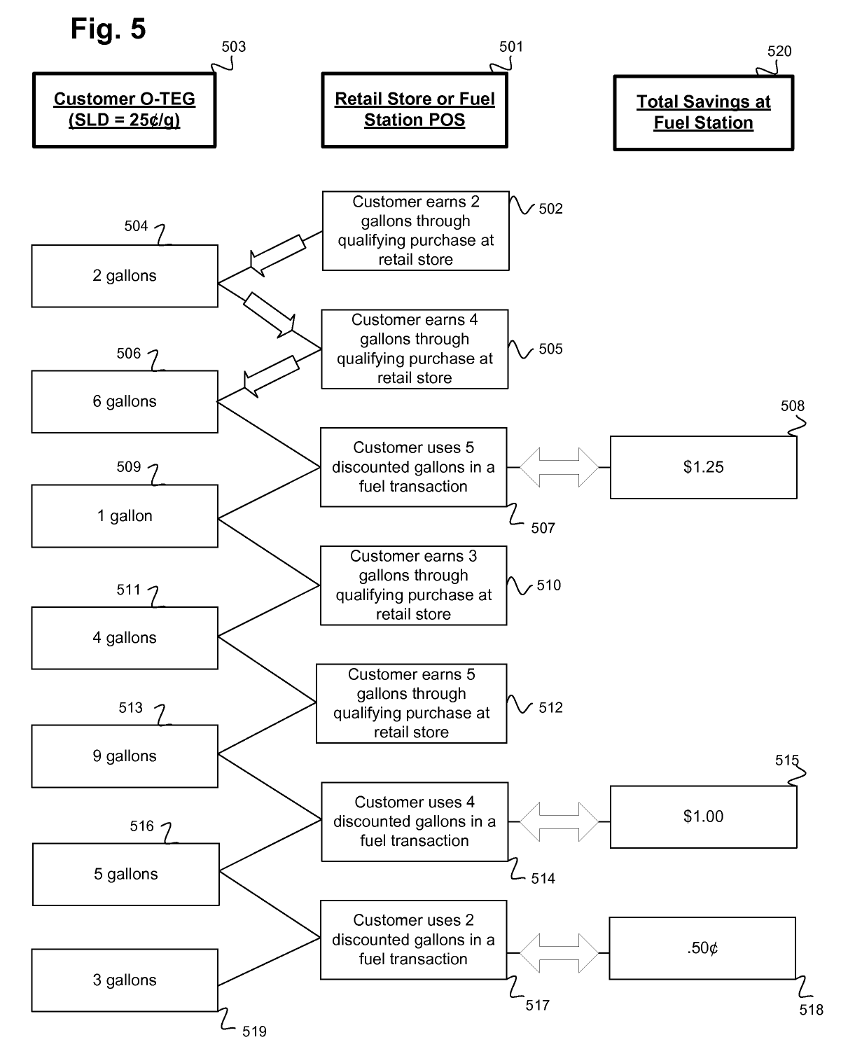

Referring to FIG. 5, in another embodiment of the present invention the customer interacts with the retail store and fuel station POS in order to for the fuel rewards to be accrued and added. The customer earns and accrues gallon rewards, and then may spend some amount of those rewards at the customer's discretion. In this embodiment, the customer is a member of a tiered rewards program and receives a fixed or standard level discount (SLD) of $0.25/gallon for some number of gallons. He earns and spends these awards at a retail store, service provider, with participating alliance member, at a fuel station, etc. 501.

In this scenario, the customer has earned 2 gallons through a qualifying purchase made at a retail store at 502, making the customer's O-TEG 503 $0.25/2 gallons 504. The customer then earns 4 gallons through a qualifying purchase made at a retail store at 505, making the customer's O-TEG 503 $0.25/6 gallons 506. The customer then uses 5 gallons in a fuel purchase transaction 507, which gives the customer a total savings 520 of $1.25 508 and leaving a residual O-TEG 503 of $0.25/1 gallon 509.

The customer then earns 3 gallons through a qualifying purchase made at a retail store at 510, making the customer's O-TEG 503 $0.25/4 gallons 511. The customer earns another 5 gallons through a qualifying purchase made at a retail store at 512, making the customer's O-TEG 503 $0.25/9 gallons 513. The customer then uses 4 gallons in a fuel purchase transaction 514, which gives the customer a total savings 520 of $1.00 515 and leaving a residual O-TEG 503 of $0.25/5 gallons 516. The customer uses another 2 gallons in a fuel purchase transaction 517, which gives the customer a total savings 520 of $0.50 518 and leaving a residual O-TEG 503 of $0.25/3 gallons 519, which he may use in a future fuel purchase, or allow to accumulate with other gallonage rewards for a future date.

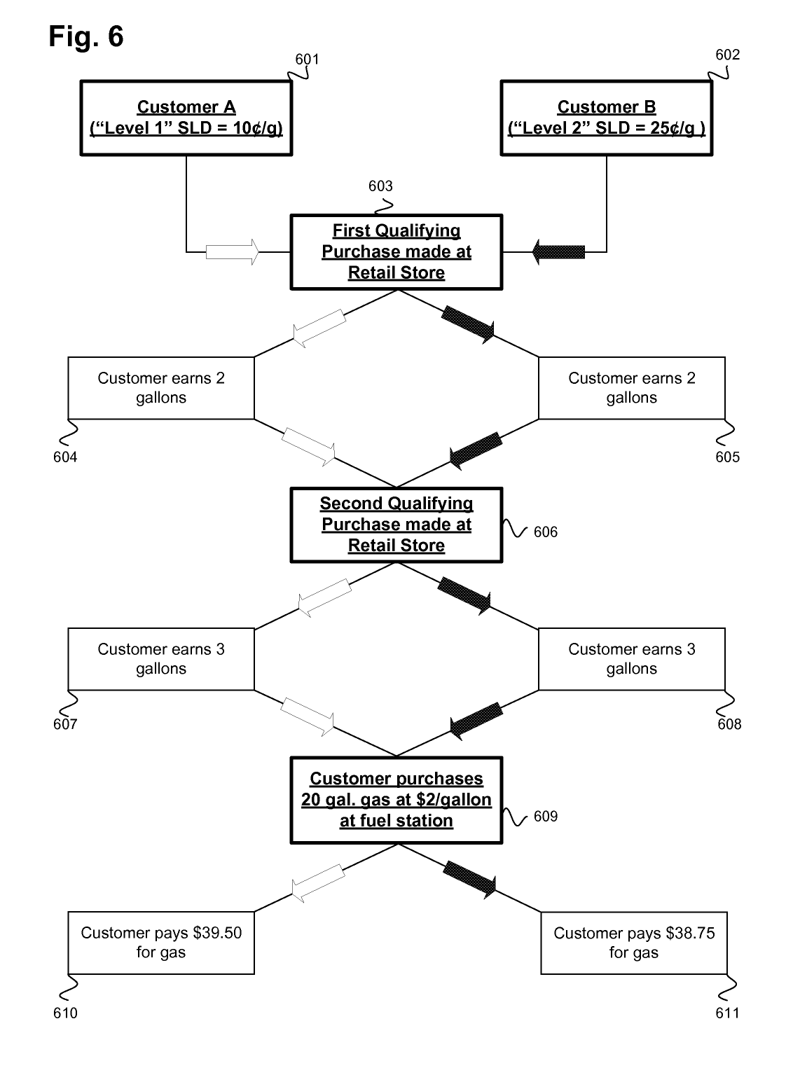

Referring now to FIG. 6, two customers on different rewards ‘tiers’ make identical purchases and receive different amounts of fuel discounts due to the different tiers. Although they are both members in the same fuel rewards loyalty program, customer A is on a tier which offers a standard level discount of $0.10/gallon 601, while customer B is on a tier which offers a standard level discount of $0.25/gallon 602. The rewards accounts of customer A and customer B are completely separate. Both customers make identical first qualifying purchases at a retail store at 603. This purchase may be a threshold amount, cross-marketed product, etc. Customer A earn 2 gallons of fuel as a result of this qualifying purchase 604, and customer B earns 2 gallons of fuel as a result of this qualifying purchase 605. Both customers make identical second qualifying purchases at a retail store 606. Customer A earn 3 gallons of fuel as a result of this qualifying purchase 607, and customer B earns 3 gallons of fuel as a result of this qualifying purchase 608. Both customers independently visit a fuel station and purchase 20 gallons of gas at $2.00/gallon at 609. Customer A's O-TEG is $0.10/5 gallons, or $0.50. Customer A thus pays $39.50 for the 20 gallons of gas 610. Customer B's O-TEG is $0.25/5 gallons, or $1.25. Customer B pays $38.75 for the 20 gallons of gas 611.

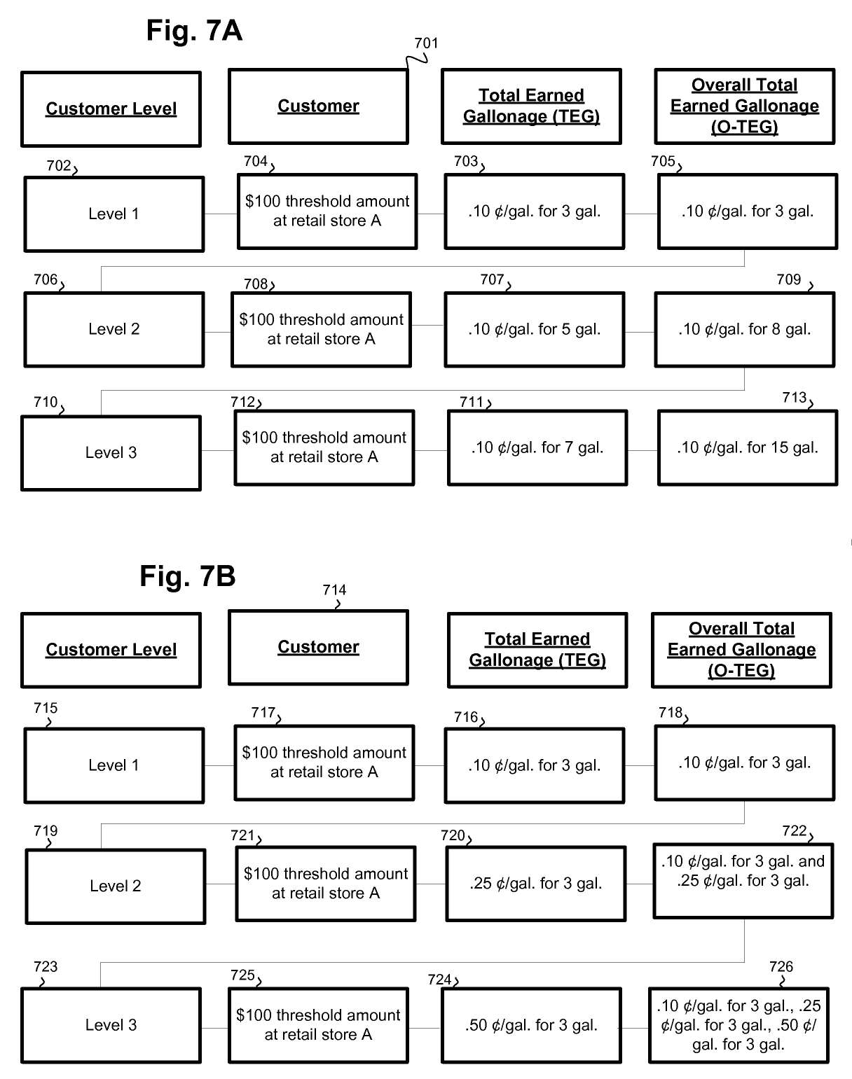

Referring to FIG. 7A, a tiered gallonage fuel rewards program might allow for customer to receive ‘promotions’ between tiers by (a) allowing a customer to earn an increasing number of gallons for similar purchases as the customer's level or ‘tier’ increases, or might allow (b) increasing the customer's standard level discount for a similar purchase as the customer's level or ‘tier’ increases. Under the first method, a customer 701 might be a member of tier Level 1 702. The customer then may earn $0.10/3 gallons 703 in response to a purchase of some threshold amount of goods (or a cross-marketed product, or some other purchasing requirement) at 704, making the customer's O-TEG $0.10/3 gallons 705. After some time, or the achievement of some criteria, the customer may be promoted to level 2 706. The customer may then earn $0.10/5 gallons in response 707 to a purchase of the same amount of threshold amount of goods (or a cross-marketed product, or some other purchasing requirement) 708, making the customer's O-TEG $0.10/8 gallons 709. After some time, or the achievement of some criteria, the customer may then be promoted to level 3 710. The customer then may earn $0.10/7 gallons 711 in response to a purchase of the same threshold amount of goods (or a cross-marketed product, or some other purchasing requirement) 712, making the customer's O-TEG $0.10/15 gallons 713.

Alternatively, referring now to FIG. 7B, under the second method a system may be tiered in a way where a customer's standard level discount for similar purchases increases as the customer's level or ‘tier’ increases. In such an embodiment, a customer 714 on tier Level 1 715 may earn $0.10/3 gallons 716 in response to a purchase of some threshold amount of goods (or a cross-marketed product, or some other purchasing requirement) 717, making the customer's O-TEG $0.10/3 gallons 718. After some time, or the achievement of some criteria, the customer may be promoted to level 2 719. The customer may then earn $0.25/3 gallons 720 in response to a purchase of the same amount of threshold amount of goods (or a cross-marketed product, or some other purchasing requirement) 721, making the customer's O-TEG $0.10/3 gallons and an additional $0.25/3 gallons 722. After some time, or the achievement of some criteria, the customer may then be promoted to level 3 723. The customer then may earn $0.50/3 gallons 724 in response to a purchase of the same threshold amount of goods (or a cross-marketed product, or some other purchasing requirement) 725, making the customer's O-TEG $0.10/3 gallons, $0.25/3 gallons, and $0.50/3 gallons 726.

Although various preferred embodiments have been described herein in detail, it will be appreciated by those skilled in the art, that variations may be made thereto without departing from the spirit of the invention or the scope of the claims.

What is claimed is:

1. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said customer identification record in response to a purchase recognized at said host computer;
adding by means of said host computer said preliminary award record associated with said customer identification record to a subsequent said preliminary award record associated with said customer identification to determine an intermediate award record, wherein said intermediate award record comprises all the discount-per-gallon awards associated with the customer;
storing said intermediate award record in a database, wherein a database module associates said intermediate award record with said customer identification record;
initiating by the customer a purchase of fuel at a fuel station with at least one fuel pump, said initiating step including identifying a customer by a fuel pump controller in operative communication with both a second reader device and a second identification module;
retrieving by said host computer said intermediate award record from said database;
recognizing, through an interaction between said database and said host computer, that said customer is eligible for a fuel station supplementary discount, wherein said fuel station supplementary discount is associated with qualifying criteria other than said customer's purchase;
creating from the interaction between said database and said host computer, a fuel station supplementary discount award record associated with said fuel station supplementary discount;
adding, by a fuel pump controller operatively connected to said host computer, said intermediate award record to said fuel station supplementary discount award record to determine a final discount record;
receiving by the customer, an amount of fuel having an associated total cost;
providing said customer an option to redeem the final discount associated with the final discount award record; and
reducing by said fuel pump the cost of said fuel by said final discount record, if said customer chooses said option.

2. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said customer identification record in response to a purchase recognized at said host computer;
recognizing, through said host computer, that the customer is eligible for a retail store supplementary discount, wherein said retail store supplementary discount is associated with qualifying criteria other than the customer's purchase;
creating at said host computer, a retail store supplementary discount award record associated with said retail station supplementary discount;
adding by means of said host computer said preliminary award record associated with said customer identification record to a subsequent said preliminary award record associated with said customer identification, and said retail store supplementary discount award record associated with a particular customer identification record to determine a final discount award record, wherein said final discount award record comprises all the discount-per-gallon awards associated with the customer and said retail store supplementary discount;
storing the final discount award record in a database, wherein a database module associates the final discount award record with the customer identification record;
initiating by the customer a purchase of fuel at a fuel station with at least one fuel pump, said initiating step including identifying a customer by a fuel pump controller in operative communication with both a second reader device and a second identification module;
retrieving by said host computer the final discount award record from the database;
receiving by the customer, an amount of fuel having an associated total cost;
providing said customer an option to redeem a final discount associated with the final discount award record; and
reducing by the fuel pump the cost of the fuel by the final discount, if said customer chooses said option.

3. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said customer identification record in response to a purchase recognized at said host computer;
recognizing, through said host computer, that the customer is eligible for a retail store supplementary discount, wherein said retail store supplementary discount is associated with qualifying criteria other than the customer's purchase;
creating at said host computer, a retail store supplementary discount award record associated with said retail station supplementary discount;
adding by means of said host computer said preliminary award record associated with said customer identification record to a subsequent said preliminary award record associated with said customer identification, and said retail store supplementary discount award record associated with a particular customer identification record to determine an intermediate discount award record, wherein said intermediate discount award record comprises all the discount-per-gallon awards associated with the customer and said retail store supplementary discount;
storing the intermediate discount award record in a database, wherein a database module associates the intermediate discount award record with the customer identification record;
initiating by the customer a purchase of fuel at a fuel station with at least one fuel pump, said initiating step including identifying a customer by a fuel pump controller in operative communication with both a second reader device and a second identification module;
retrieving by said host computer said intermediate award record from said database;
recognizing, through an interaction between said database and said host computer, that said customer is eligible for a fuel station supplementary discount, wherein said fuel station supplementary discount is associated with qualifying criteria other than said customer's purchase;
creating from the interaction between said database and said host computer, a fuel station supplementary discount award record associated with said fuel station supplementary discount;
adding, by a fuel pump controller operatively connected to said host computer, said intermediate award record to said fuel station supplementary discount award record to determine a final discount record;
receiving by the customer, an amount of fuel having an associated total cost;
providing said customer an option to redeem the final discount associated with the final discount award record; and
reducing by said fuel pump the cost of said fuel by said final discount record, if said customer chooses said option.

4. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
recognizing, through said host computer, that the customer is eligible for a retail store supplementary discount;
creating at said host computer, a retail store supplementary discount award record associated with said retail station supplementary discount;
storing said retail store supplementary discount award record in a database, wherein a database module associates said retail store supplementary discount award record with the customer identification record;
initiating by the customer a purchase of fuel at a fuel station with at least one fuel pump, said initiating step including identifying a customer by a fuel pump controller in operative communication with both a second reader device and a second identification module;
retrieving by said host computer said retail store supplementary discount award record from said database;
recognizing, through an interaction between said database and said host computer, that said customer is eligible for a fuel station supplementary discount;
creating from the interaction between said database and said host computer, a fuel station supplementary discount award record associated with said fuel station supplementary discount;
adding, by a fuel pump controller operatively connected to said host computer, retail store supplementary discount award record to said fuel station supplementary discount award record to determine a final discount record;
receiving by the customer, an amount of fuel having an associated total cost;
providing said customer an option to redeem the final discount associated with the final discount award record; and
reducing by said fuel pump the cost of said fuel by said final discount record, if said customer chooses said option.

5. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
recognizing, through said host computer, that the customer is eligible for a retail store supplementary discount;
creating at said host computer, a retail store supplementary discount award record associated with said retail station supplementary discount;
storing said retail store supplementary discount award record in a database, wherein a database module associates said retail store supplementary discount award record with the customer identification record;
initiating by the customer a purchase of fuel at a fuel station with at least one fuel pump, said initiating step including identifying a customer by a fuel pump controller in operative communication with both a second reader device and a second identification module;
retrieving by said host computer said retail store supplementary discount award record from said database;
receiving by the customer, an amount of fuel having an associated total cost;
providing said customer an option to redeem the retail store supplementary discount award associated with the retail store supplementary discount award record; and
reducing by said fuel pump the cost of said fuel by said retail store supplementary discount award record, if said customer chooses said option.

6. A computer-implemented method of providing a discount for fuel to a customer, said method comprising:
initiating by the customer a purchase of fuel at a fuel station with at least one fuel pump, said initiating step including identifying a customer by a fuel pump controller in operative communication with both a second reader device and a second identification module;
recognizing, through an interaction between said database and said host computer, that said customer is eligible for a fuel station supplementary discount;
creating from the interaction between said database and said host computer, a fuel station supplementary discount award record associated with said fuel station supplementary discount;
receiving by the customer, an amount of fuel having an associated total cost;
providing said customer an option to redeem the fuel station supplementary discount associated with the fuel station supplementary discount award record; and
reducing by said fuel pump the cost of said fuel by said fuel station supplementary discount award record, if said customer chooses said option.

7. The computer-implemented method of claim 2, 3, 4, or 5 wherein said retail store supplementary discount is associated with a customer's status.

8. The computer-implemented method of claim 2, 3, 4, or 5 wherein said retail store supplementary discount is associated with a customer's achievement of a pre-determined criteria.

9. The computer-implemented method of claim 1, 3, 4, or 6 wherein said fuel station supplementary discount is associated with a customer's status.

10. The computer-implemented method of claim 1, 3, 4, or 6 wherein said fuel station supplementary discount is associated with a customer's achievement of a pre-determined criteria.

11. A system for providing a discount for fuel to a customer, said system comprising:
a retail store point-of-sale for:
enabling a customer to make at least one qualifying purchase;
awarding the customer at least one discount-per-gallon in response to the at least one purchase;
adding a plurality of at least one discounts-per-gallon to determine a first intermediate discount-per-gallon; and
awarding the customer a retail store supplementary discount;
a first reader connected to the retail store point-of-sale for reading a first customer identification;
a database for storing first intermediate discount-per-gallon and the retail store supplementary discount and associating both discounts with the customer;
a nozzle for dispensing the fuel;
a second reader connected to the fuel station point-of-sale for reading a second customer identification;
a fuel station point-of-sale for:
enabling a customer to make at least one fuel purchase associated with a total cost;
awarding the customer a fuel station supplementary discount;
adding the first intermediate discount-per-gallon, retail store supplementary discount, and fuel station supplementary discount to determine a final discount; and
subtracting the final discount from the total cost.

12. A system for providing a discount for fuel to a customer, said system comprising:
a retail store point-of-sale for:
enabling a customer to make at least one qualifying purchase;
awarding the customer at least one discount-per-gallon in response to the at least one purchase;
adding a plurality of at least one discounts-per-gallon to determine a first intermediate discount-per-gallon; and
awarding the customer a retail store supplementary discount;
a first reader connected to the retail store point-of-sale for reading a first customer identification;
a database for storing the first intermediate discount-per-gallon and the retail store supplementary discount and associating both discounts with the customer as a final discount;
a nozzle for dispensing the fuel;
a second reader connected to a fuel station point-of-sale for
reading a second customer identification;
enabling a customer to make at least one fuel purchase associated with a total cost;
subtracting the final discount from the total cost

13. A system for providing a discount for fuel to a customer, said system comprising:
a retail store point-of-sale for:
enabling a customer to make at least one qualifying purchase;
awarding the customer at least one discount-per-gallon in response to the at least one purchase;
adding a plurality of at least one discounts-per-gallon to determine a first intermediate discount-per-gallon award; and
a first reader connected to the retail store point-of-sale for reading a first customer identification;
a database for storing the first intermediate discount-per-gallon award and associating said discount-per-gallon with the customer;
a nozzle for dispensing fuel;
a reader connected to a fuel station point-of-sale for
reading a customer identification;
associating the customer identification with the first intermediate discount-per-gallon award
enabling a customer to make at least one fuel purchase associated with a total cost;
awarding the customer a fuel station supplementary discount;
adding the first intermediate discount-per-gallon award and fuel station supplementary award to determine a final discount
subtracting the final discount from the total cost

14. A system for providing a discount for fuel to a customer, said system comprising:
means for identifying a customer by a store;
means for awarding at least one discount-per-gallon for fuel to the customer in response to at least one purchase;
means for adding said discounts-per-gallon to determine a first intermediate discount-per-gallon for fuel;
means for awarding at least one supplementary discount;
means for storing the first intermediate discount and the supplementary discount;
means for identifying a customer by a fuel station;
means for distributing fuel to the customer;
means for adding the first intermediate discount and the supplementary discount to determine a final discount; and
means for reducing the cost of the fuel by the final discount.

15. A computer-implemented method of providing a discount for fuel to a customer, said method comprising:
identifying a customer to a retail store by means of a first reader device in operative communication with a host computer, said host computer in communication with an identification module, said identification module creating and said customer thereby being associated with a customer identification record;
creating and maintaining an award record at said host computer, said award record comprising a fixed discount on a number of gallons, said award associated with said customer identification record in response to a purchase recognized at said host computer;
storing said award record in a database, wherein a database module associates said award record with said customer identification record;
initiating by the customer a purchase of fuel at a fuel station with at least one fuel pump, said initiating step including identifying a customer by a fuel pump controller in operative communication with both a second reader device and a second identification module;
retrieving by said host computer said award record from said database;
recognizing, through an interaction between said database and said host computer, that said customer is associated with said award record;
receiving by the customer, an amount of fuel having an associated total cost; and
reducing by said fuel pump the cost of said fuel by said fixed discount for said number of gallons associated with said award record.

16. The computer-implemented method of claim 15, wherein said fixed discount is determined by said customer's achievement of a status.

17. The computer-implemented method of claim 16, wherein said status is established by the retail store.

18. The computer-implemented method of claim 16, wherein said status is established by the fuel store.

19. The computer-implemented method of claim 15, wherein said fixed discount is determined by said customer's achievement of a pre-determined criteria.

20. The computer-implemented method of claim 19, wherein said pre-determined criteria is established by the retail store.

21. The computer-implemented method of claim 19, wherein said pre-determined criteria is established by the fuel station.

22. A computer-implemented method of providing a discount for fuel to a customer, said method comprising:
issuing a stored value card to a customer;
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said stored value card and said customer identification record;
recognizing, through said host computer, that the customer is eligible for a retail store supplementary discount, wherein said retail store supplementary discount is associated with at least one of a qualifying criteria and a qualifying status other than a purchase of the customer;
creating at said host computer, a retail store supplementary discount award record associated with said retail store supplementary discount;
storing said retail store supplementary discount award record in a database, wherein a database module associates said retail store supplementary discount award record with said customer identification record;
initiating by the customer a purchase of fuel with said stored value card at a fuel station with at least one fuel pump, said initiating step including identifying a customer by a fuel pump controller in operative communication with both a second reader device and a second identification module;
retrieving by said host computer said retail store supplementary discount award record from said database;
recognizing, through an interaction between said database and said host computer, that said customer is eligible for a fuel station supplementary discount, wherein said fuel station supplementary discount is associated with qualifying criteria other than said customer's purchase;
creating from the interaction between said database and said host computer, a fuel station supplementary discount award record associated with said fuel station supplementary discount;
adding, by a fuel pump controller operatively connected to said host computer, said discount-per-gallon award for fuel associated with said stored value card, said retail store supplementary discount, and said fuel station supplementary discount award to determine a final discount;
receiving by the customer, an amount of fuel having an associated total cost;
providing said customer an option to redeem the final discount associated with the final discount award record; and
reducing by said fuel pump the cost of said fuel by said final discount record, if said customer chooses said option.

23. A computer-implemented method of providing a discount for fuel to a customer, said method comprising:
issuing a stored value card to a customer;
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said stored value card and said customer identification record;
recognizing, through said host computer, that the customer is eligible for a retail store supplementary discount, wherein said retail store supplementary discount is associated with at least one of a qualifying criteria and a qualifying status other than a purchase of the customer;
creating at said host computer, a retail store supplementary discount award record associated with said retail station supplementary discount;
storing said retail store supplementary discount award record in a database, wherein a database module associates said retail store supplementary discount award record with said customer identification record;
initiating by the customer a purchase of fuel with said stored value card at a fuel station with at least one fuel pump, said initiating step including identifying a customer by a fuel pump controller in operative communication with both a second reader device and a second identification module;
retrieving by said host computer said a retail store supplementary discount intermediate award record from said database;
recognizing, through an interaction between said database and said host computer, that said customer is eligible for a fuel station supplementary discount, wherein said fuel station supplementary discount is associated with at least one of a qualifying criteria and a qualifying status other than a purchase of the customer;
creating from the interaction between said database and said host computer, a fuel station supplementary discount award record associated with said fuel station supplementary discount;
adding, by a fuel pump controller operatively connected to said host computer, said a discount-per-gallon award for fuel associated with said stored value card and said retail store supplementary discount to determine a final discount record;
receiving by the customer, an amount of fuel having an associated total cost;
providing said customer an option to redeem the final discount associated with the final discount award record; and
reducing by said fuel pump the cost of said fuel by said final discount record, if said customer chooses said option.

24. A computer-implemented method of providing a discount for fuel to a customer, said method comprising:
issuing a stored value card to a customer;
identifying a customer to a retail store by means of a first reader device in operative communication with a host computer, said host computer in communication with an identification module, said identification module creating and said customer thereby being associated with a customer identification record;
creating and maintaining a preliminary award record at said host computer, said preliminary award record comprising a discount-per-gallon award for fuel associated with said stored value card and said customer identification record;
initiating by the customer a purchase of fuel with said stored value card at a fuel station with at least one fuel pump, said initiating step including identifying a customer by a fuel pump controller in operative communication with both a second reader device and a second identification module;
recognizing, through an interaction between a database and said host computer, that said customer is eligible for a fuel station supplementary discount, wherein said fuel station supplementary discount is associated with at least one of a qualifying criteria and a qualifying status other than a purchase of the customer;
creating from the interaction between said database and said host computer, a fuel station supplementary discount award record associated with said fuel station supplementary discount;
adding, by a fuel pump controller operatively connected to said host computer, said a discount-per-gallon award for fuel associated with said stored value card and said fuel station supplementary discount award record to determine a final discount record;
receiving by the customer, an amount of fuel having an associated total cost;
providing said customer an option to redeem the final discount associated with the final discount award record; and
reducing by said fuel pump the cost of said fuel by said final discount record, if said customer chooses said option.

25. A computer-implemented method of providing a discount for fuel to a card user, said method comprising:
issuing a stored value card;
identifying said stored value card to a retail store by means of a first reader device in operative communication with a host computer, said host computer in communication with an identification module, said identification module creating and said stored value card thereby being associated with a card identification record;
creating and maintaining a preliminary award record at said host computer, said preliminary award record comprising a discount-per-gallon award for fuel associated with said stored value card and said card identification record;
recognizing, through said host computer, that the card is eligible for a retail store supplementary discount, wherein said retail store supplementary discount is associated with at least one of a qualifying criteria and a qualifying status other than a purchase;
creating at said host computer, a retail store supplementary discount award record associated with said retail store supplementary discount;
storing said retail store supplementary discount award record in a database, wherein a database module associates said retail store supplementary discount award record with said card identification record;
initiating by a user of the card a fuel purchase with said stored value card at a fuel station with at least one fuel pump, said initiating step including identifying the card by a fuel pump controller in operative communication with both a second reader device and a second identification module;
retrieving by said host computer said retail store supplementary discount award record from said database;
recognizing, through an interaction between said database and said host computer, that said card is eligible for a fuel station supplementary discount, wherein said fuel station supplementary discount is associated with qualifying criteria other than said fuel purchase;
creating from the interaction between said database and said host computer, a fuel station supplementary discount award record associated with said fuel station supplementary discount;
adding, by a fuel pump controller operatively connected to said host computer, said discount-per-gallon award for fuel associated with said stored value card, said retail store supplementary discount, and said fuel station supplementary discount award to determine a final discount;
receiving an amount of fuel having an associated total cost;
providing said user an option to redeem the final discount associated with the final discount award record; and
reducing by said fuel pump the cost of said fuel by said final discount record, if said user chooses said option.
